(19) United States
(12) Patent Application Publication
(10) Pub. No.: US 2020/0265839 A1
(43) Pub. Date: Aug. 20, 2020

(54) GLASSES WITH SUBTITLES

(71) Applicant: John T. McAnallan, San Anselmo, CA (US)

(72) Inventor: John T. McAnallan, San Anselmo, CA (US)

(21) Appl. No.: 16/794,582

(22) Filed: Feb. 19, 2020

Related U.S. Application Data
(60) Provisional application No. 62/808,160, filed on Feb. 20, 2019.

(51) Int. Cl. G10L 15/22; H04M 1/725; G10L 15/183; G09G 5/22; G02B 27/01

(52) U.S. Cl. CPC G10L 15/22; H04M 1/7253; G10L 15/183; G02B 2027/0178; G02B 27/0172; G09G 2354/00; G02B 2027/0141; G09G 5/22

(57) ABSTRACT

The present inventions provides methods and components to produce a phone app as well as hardware and other software to implement a heads-up type display upon a pair of either standard glasses or prescription glasses, with said glasses linked to the phone app by short range communication methods, including but not limited to WI-FI, Bluetooth or other means to produce a subtitle upon the lenses of the glasses. Advantageously, the glasses provide an alternative to hearing aids for the hearing impaired.

### CROSS-REFERENCE TO RELATED APPLICATIONS

The present application claims priority to U.S. Provisional Patent Application Ser. No. 62/808,160 filed on Feb. 20, 2019 entitled “Glasses with Subtitles”, the disclosure of which is hereby incorporated in its entirety at least by reference.

### BACKGROUND OF THE INVENTION

### 1. Field of the Invention

The invention generally relates to heads up display systems, and more particularly, the invention relates to means and methods of creating eyeglasses that interact with a smartphone to provide translations, hard to hear audio information, and other information in real time.

### 2. Description of Related Art

The known related art fails to anticipate or disclose the principles of the present invention. While general heads-up display systems are known, none provide a real time application suitable for consumers who may be hard of hearing or want translation or other information in real time. With our growing population of older people with hearing problems, there is a need in the art for the present invention.

### BRIEF SUMMARY OF THE INVENTION

The following presents a simplified summary of some embodiments of the invention in order to provide a basic understanding of the invention. This summary is not an extensive overview of the invention. It is not intended to identify key/critical elements of the invention or to delineate the scope of the invention. Its sole purpose is to present some embodiments of the invention in a simplified form as a prelude to the more detailed description that is presented later.

The present inventions overcomes shortfalls in the related art by presenting an unobvious and unique combination and configuration of methods and components to produce a mobile phone software application as well as hardware and other software to implement a heads-up type display upon a pair of either standard glasses or prescription glasses, with said glasses linked to the phone app by short range communication methods, including but not limited to WI-FI, Bluetooth or other means to produce a subtitle upon the lenses of the glasses. Advantageously, the glasses provide an alternative to hearing aids for the hearing impaired.

In order to do so, glasses are provided, comprising a frame; a pair of lenses having a display configured to visually display subtitle text; a number of electrical components including a first wireless communication device configured to communicate with a smartphone having a microphone and a second wireless communication device, the smartphone configured to execute a mobile software application, wherein the mobile software application is configured to capture verbal speech data via the microphone, then send the speech data to the first wireless communication device via the second communication device such that the subtitle text matches the captured verbal speech data.

In one embodiment, the number of electrical components further include a rechargeable battery and microprocessor. In one embodiment, the first and second wireless communication devices communicate via Bluetooth. In another embodiment, temples, a bridge, and a nose pad are provided. In one embodiment, the display is semi-transparent or full-transparent allowing a user to see through the display. In one embodiment, the subtitle text is configured to scroll across the display. In one embodiment, the mobile application software is configured to translate the verbal speech data to a specific language of subtitle text.

In another aspect of the invention, glasses are provided, comprising a frame; a pair of lenses having a display; a number of electrical components including a microphone, microcontroller, and data converter, wherein the number of electrical components are configured to convert speech data and covert the speech data to subtitle text on the display.

The foregoing has outlined rather broadly the more pertinent and important features of the present disclosure so that the detailed description of the invention that follows may be better understood and so that the present contribution to the art can be more fully appreciated. Additional features of the invention will be described hereinafter which form the subject of the claims of the invention. It should be appreciated by those skilled in the art that the conception and the disclosed specific methods and structures may be readily utilized as a basis for modifying or designing other structures for carrying out the same purposes of the present disclosure. It should be realized by those skilled in the art that such equivalent structures do not depart from the spirit and scope of the invention as set forth in the appended claims.

### BRIEF DESCRIPTION OF THE SEVERAL VIEWS OF THE DRAWINGS

Other features and advantages of the present invention will become apparent when the following detailed description is read in conjunction with the accompanying drawings, in which:

FIG. 1 is a perspective view of glasses with subtitles according to an embodiment of the present invention.

FIG. 2 is a smartphone with a display for use with the glasses of FIG. 1 according to an embodiment of the present invention.

FIG. 3 is a block diagram illustrating electrical components 300 positioned in the glasses 100 of FIG. 1 according to an embodiment of the present invention.

### DETAILED DESCRIPTION OF THE PREFERRED EMBODIMENT

The following description is provided to enable any person skilled in the art to make and use the invention and sets forth the best modes contemplated by the inventor of carrying out his invention. Various modifications, however, will remain readily apparent to those skilled in the art, since the general principles of the present invention have been defined herein to specifically provide glasses with subtitles.

Unless the context clearly requires otherwise, throughout the description and the claims, the words “comprise,” “comprising” and the like are to be construed in an inclusive sense as opposed to an exclusive or exhaustive sense; that is to say, in a sense of “including, but not limited to.” Words “a” or “an”, or other words using the singular or plural number also include the plural or singular number, respectively. Additionally, the words “herein,” “above,” “below,” and words of similar import, when used in this application, shall refer to this application as a whole and not to any particular portions of this application.

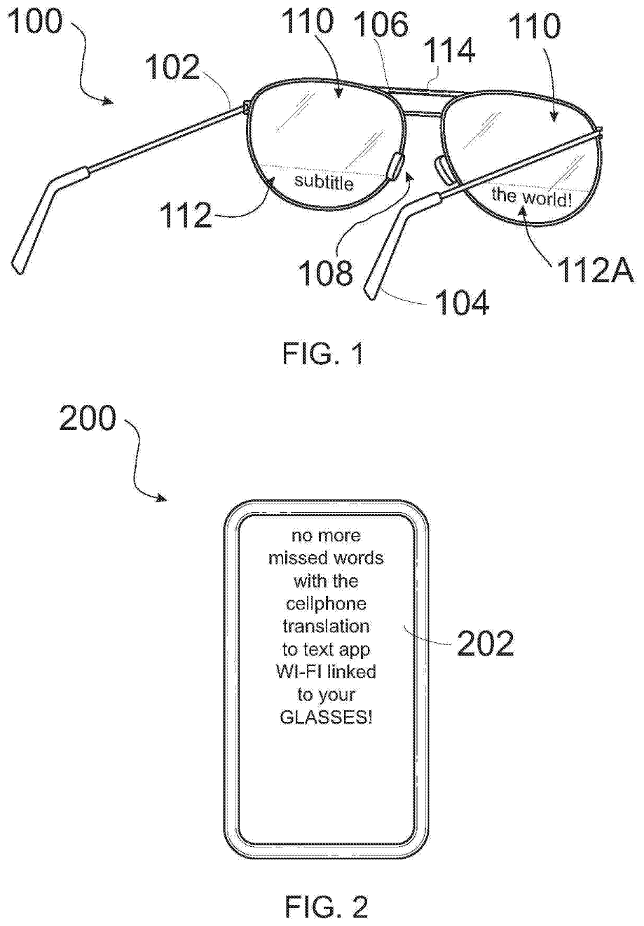

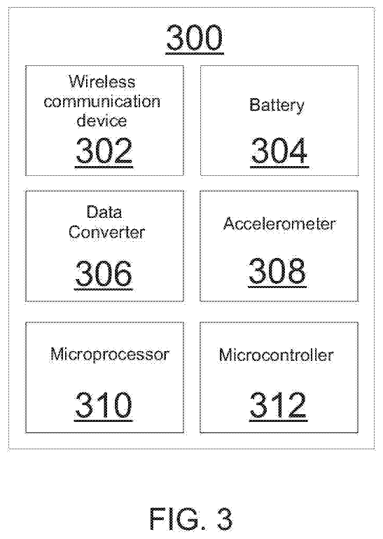

FIG. 1 is a perspective view of glasses 100 with subtitles according to an embodiment of the present invention. Referring now to FIG. 1, the glasses are illustrated. In one embodiment, the glasses comprise most the typical components found in glasses, including but not limited to a frame 102, temples 104, bridge 106, nose pads 108, and lenses 110. It should be understood that the glasses design and structure may vary without departing from the spirit of the invention, including but not limited to construction of components, i.e. without nose pads, or different material frames, bridge, and temples designs. The critical aspect is producing glasses which can be worn by a user comprising lenses 110 having a display 112. In some embodiments, the display 112 is a portion of the lenses 110, wherein the display portion is semi-transparent or full transparent allowing the user to see through the display when not in use (and during use). In some embodiments, the transparency or shade of the display may change depending on the environmental conditions, such as sunlight and darkness. The display should be an adequate size such that legible sub title text 112A may scroll across the display. In one embodiment, electronic components (300; FIG. 3) are positioned in a compartment 114 in the frame, nose pads, bridge, and/or temples. The location of the electrical components will depend on the construction, design, shape, and material selections for the glasses 100. The electronic components will be discussed in greater details below. Further, the lenses may be prescription, natural, sunglasses, etc.

FIG. 2 is a smartphone 200 with a screen display 202 for use with the glasses 100 of FIG. 1 according to an embodiment of the present invention. Referring now to FIG. 2, the smartphone 200 is illustrated. The smartphone includes the typical hardware and software components well known in the art. In one embodiment, the smartphone is configured to execute a mobile software application that is configured to work in conjunction with the glasses 100. In one embodiment, the mobile application software is configured to use the smartphone's microphone, wireless connection capability, processing power, and other features of the smartphone such that the software is configured to identify, translate, and transmit text to the display 112 of the glasses.

FIG. 3 is a block diagram illustrating electrical components 300 positioned in the glasses 100 of FIG. 1 according to an embodiment of the present invention. Referring now to FIG. 3, the electrical components 300, may include but are not limited to a wireless communication device 302, battery 304, data converter 306, accelerometer 308, microprocessor 310, and/or a microcontroller 312. The wireless communication device is a short range communication device configured to communicate with the smartphone, such as a Wi-Fi antenna, Bluetooth, or similar. In one embodiment, the battery is configured to be a rechargeable battery, wherein the battery supplies the necessary power to run the electrical components as well known in the art. In other embodiments, the battery is connected to one or more solar cells configured to charge the battery. The microcontroller, processor, and data converter work together to receive the data signal sent from the mobile application software and convert the data signal to text on the display 112 of the glasses. The text appearing on the display 112 will include the conversation that is going on within range of the smartphone that the user has on his or her person and the mobile application software will translate the speech into text as shown in FIG. 2. In one embodiment, the accelerometer is configured to detect when the glasses are worn or stored (not in use), such that the battery reserves its power when the glasses are not in use. In one embodiment, when the frames are in a crossed position (not shown) it is an indication the glasses are not in use.

In some embodiments, the phone will also show text for incoming phone calls in high noise environments. The text as shown is a variation of the military “Heads up display” used in their fighter aircraft but has never been suggested for glasses or as an aid to hearing. In some embodiments, the mobile application is configured to translate different languages to the user so that they can follow what other people are saying in languages the user doesn't understand.

Although the invention has been described in considerable detail in language specific to structural features, it is to be understood that the invention defined in the appended claims is not necessarily limited to the specific features described. Rather, the specific features are disclosed as exemplary preferred forms of implementing the claimed invention. Stated otherwise, it is to be understood that the phraseology and terminology employed herein, as well as the abstract, are for the purpose of description and should not be regarded as limiting. Therefore, while exemplary illustrative embodiments of the invention have been described, numerous variations and alternative embodiments will occur to those skilled in the art. Such variations and alternate embodiments are contemplated, and can be made without departing from the spirit and scope of the invention. For instance, although the disclosed glasses are configured to work in conjunction with a smartphone, the microprocessor can perform all the functions of the smartphone such that only the glasses are needed during use. In this embodiment, the glasses would also include a microphone and an additional data converter configured to convert the analog sound picked up by the microphone into digital text. Advantageously, in this case, the glasses can function as a standalone unit without the need for a smartphone and the accompanying mobile application software.

It should further be noted that throughout the entire disclosure, the labels such as left, right, front, back, top, bottom, forward, reverse, clockwise, counter clockwise, up, down, or other similar terms such as upper, lower, aft, fore, vertical, horizontal, oblique, proximal, distal, parallel, perpendicular, transverse, longitudinal, etc. have been used for convenience purposes only and are not intended to imply any particular fixed direction or orientation. Instead, they are used to reflect relative locations and/or directions/orientations between various portions of an object.

In addition, reference to “first,” “second,” “third,” and etc. members throughout the disclosure (and in particular, claims) are not used to show a serial or numerical limitation but instead are used to distinguish or identify the various members of the group.

What is claimed is:

1. Glasses comprising:
a frame;
a pair of lenses having a display configured to visually display subtitle text;
a number of electrical components including a first wireless communication device configured to communicate with a smartphone having a microphone and a second wireless communication device, the smartphone configured to execute a mobile software application, wherein the mobile software application is configured to capture verbal speech data via the microphone, then send the speech data to the first wireless communication device via the second communication device such that the subtitle text matches the captured verbal speech data.

2. The glasses of claim 1, wherein the number of electrical components further include a rechargeable battery and microprocessor.

3. The glasses of claim 1, wherein the first and second wireless communication devices communicate via Bluetooth.

4. The glasses of claim 1, further comprising temples, a bridge, and a nose pad.

5. The glasses of claim 1, wherein the display is semi-transparent or full-transparent allowing a user to see through the display.

6. The glasses of claim 1, wherein the subtitle text is configured to scroll across the display.

7. The glasses of claim 1, wherein the mobile application software is configured to translate the verbal speech data to a specific language of subtitle text.

8. Glasses comprising:
a frame;
a pair of lenses having a display;
a number of electrical components including a microphone, microcontroller, and data converter, wherein the number of electrical components are configured to convert speech data and covert the speech data to subtitle text on the display.
